(19) United States
(12) Patent Application Publication
(10) Pub. No.: US 2025/0266505 A1
(43) Pub. Date: Aug. 21, 2025

(54) AN AQUEOUS ELECTROLYTE

(71) Applicant: NANYANG TECHNOLOGICAL UNIVERSITY, Singapore (SG)

(72) Inventors: Yong Sheng Rodney CHUA, Singapore (SG); Yi CAI, Singapore (SG); Jun Jie Ernest TANG, Singapore (SG); Madhavi SRINIVASAN, Singapore (SG)

(21) Appl. No.: 18/559,299

(22) PCT Filed: May 18, 2022
(86) PCT No.: PCT/SG2022/050333

§ 371 Date: Nov. 6, 2023

(30) Foreign Application Priority Data
May 18, 2021 (SG) 10202105207U

(51) Int. Cl. H01M 10/36; H01M 10/04

(52) U.S. Cl. CPC H01M 10/36; H01M 10/0427; H01M 2300/0002

(57) ABSTRACT

There is provided an aqueous electrolyte for a battery, including a water-based solvent having dissolved therein a mixture of a sodium-based salt and a trifluoromethanesulfonate-based salt, and a battery including an anode and a cathode, and the aqueous electrolyte ionically coupling the anode and the cathode.

### CROSS-REFERENCE TO RELATED APPLICATION

This application claims the benefit of priority of Singapore Patent Application No. 10202105207U, filed 18 May 2021, the contents of it being hereby incorporated by reference in its entirety for all purposes.

### TECHNICAL FIELD

An aspect of the disclosure relates to an aqueous electrolyte for a battery. Another aspect of the disclosure relates to a battery including an anode and a cathode, and an aqueous electrolyte ionically coupling the anode and the cathode.

### BACKGROUND

The transition towards cleaner and sustainable renewable energies to combat climate change and depleting fossil fuel reserves require a reliable stationary energy storage system due to the intermittent nature of renewable resources. Rechargeable batteries based on lithium-ion chemistry have played a vital role in the energy storage of renewable energies due to their superior energy densities and efficiencies. However, scaling up of lithium-ion batteries (LiBs) for large stationary energy storage applications can be costly. The rising cost of lithium is due to the ever-rising global energy demand pressurizing the relatively low supply of lithium resources and other high costs associated with manufacturing and recycling, calling for sustainable energy storage alternatives. Further, conventional LiBs pose an imminent risk of fire explosion due to highly volatile and flammable electrolytes.

Therefore, there remains a need to provide an improved electrolyte for a battery. There is also a need to provide a battery including an improved electrolyte.

### SUMMARY

In a first aspect, there is provided an aqueous electrolyte for a battery, including a water-based solvent having dissolved therein a mixture of a sodium-based salt and a trifluoromethanesulfonate-based salt.

In a second aspect, there is provided a battery including an anode and a cathode, and an aqueous electrolyte ionically coupling the anode and the cathode, wherein the aqueous electrolyte includes a water-based solvent, having dissolved therein a mixture of a sodium-based salt and a trifluoromethanesulfonate-based salt.

### BRIEF DESCRIPTION OF THE DRAWINGS

The invention will be better understood with reference to the detailed description when considered in conjunction with the non-limiting examples and the accompanying drawings, in which:

FIG. 1 schematically shows a rainwater-based rechargeable energy storage system according to an embodiment of the invention;

FIG. 2 shows the collection of rainwater being carried out by placing a plastic beaker at the edge of the unsheltered stairway to collect the flowing rainwater ((a) and (b)), the rainwater is then transferred to a glass flask for containment and storage ((c) and (d)), and (e), measuring the pH of the collected rainwater, which is about 5;

FIG. 3 schematically shows electrochemical cell configurations wherein (a) and (b) show different coin cell (CR2032) configurations and (c) shows a pouch cell configuration;

FIG. 4 shows the electrochemical stability window of different salt content in the rainwater-based electrolyte;

FIG. 5 shows the electrochemical stability window and pH of rainwater-based electrolytes with and without dimethyl sulfoxide (DMSO) additives;

FIG. 6 shows the electrochemical stability performance of rainwater-based energy rechargeable storage system based on a Prussian blue analogue (PBA)/zinc (Zn) full cell (CR2032 coin cell);

FIG. 7 shows the galvanostatic charge and discharge (GCD) curves of rainwater-based rechargeable energy storage system based on PBA/Zn full cell at different cycles (CR2032 coin cell);

FIG. 8 shows the cycling performance of rainwater-based rechargeable energy storage system based on PBA/Zn full cell (pouch cell);

FIG. 9 shows the GCD curves of rainwater-based rechargeable energy storage system based on PBA/Zn full cell at different cycles (pouch cell);

FIG. 10 shows the linear sweep voltammetry curves of rainwater-based electrolyte formulations, without and with different polar aprotic-based additives (DMSO, dimethylformamide (DMF), and acetonitrile (ACN));

FIG. 11 shows the cycling performance of PBA/Zn cycled in rainwater-based electrolyte formulations, without and with different polar aprotic-based additives (DMSO, DMF, and ACN);

FIG. 12A shows the GCD curves of PBA/Zn cycled in rainwater-based electrolyte formulations, without any additive;

FIG. 12B shows the GCD curves of PBA/Zn cycled in rainwater-based electrolyte formulations, wherein the additive is DMSO;

FIG. 12C shows the GCD curves of PBA/Zn cycled in rainwater-based electrolyte formulations, wherein the additive is DMF;

FIG. 12D shows the GCD curves of PBA/Zn cycled in rainwater-based electrolyte formulations, wherein the additive is ACN;

FIG. 13 shows the linear sweep voltammetry curves of rainwater-based electrolyte formulations with an alternative polar protic-based additive, ethanol (ETH);

FIG. 14A shows the GCD curves of PBA/Zn cycled in rainwater-based electrolyte formulations with an alternative polar protic-based additive, ETH;

FIG. 14B shows the cycling performance of PBA/Zn cycled in rainwater-based electrolyte formulations with an alternative polar protic-based additive, ETH;

FIG. 15A shows the linear sweep voltammetry curves of rainwater-based electrolyte formulation with sodium nitrate;

FIG. 15B shows the linear sweep voltammetry curves of rainwater-based electrolyte formulation with sodium chloride;

FIG. 15C shows the linear sweep voltammetry curves of rainwater-based electrolyte formulation with sodium acetate;

FIG. 15D shows the linear sweep voltammetry curves of rainwater-based electrolyte formulation with sodium sulfate;

FIG. 16A shows the GCD curves of PBA/Zn cycled in rainwater (Rw)-based electrolyte formulations with sodium nitrate and DMSO as additive;

FIG. 16B shows the GCD curves of PBA/Zn cycled in rainwater-based electrolyte formulations with sodium nitrate and DMF as additive;

FIG. 16C shows the GCD curves of PBA/Zn cycled in rainwater-based electrolyte formulations with sodium chloride and ETH as additive;

FIG. 16D shows the GCD curves of PBA/Zn cycled in rainwater-based electrolyte formulations with sodium chloride and DMF as additive;

FIG. 16E shows the GCD curves of PBA/Zn cycled in rainwater-based electrolyte formulations with sodium acetate and DMSO as additive;

FIG. 16F shows the GCD curves of PBA/Zn cycled in rainwater-based electrolyte formulations with sodium sulfate and DMSO as additive;

FIG. 17A shows the structural characterization of electrolytes;

FIG. 17B shows the electrochemical stability window of electrolytes;

FIG. 18A shows the GCD curves of PBA/Zn tested in NaZn-WiS as prepared in Example 4;

FIG. 18B shows the GCD curves of PBA/Zn tested in NaZn-WiSA as prepared in Example 4;

FIG. 18C shows the cycling performance of PBA/Zn tested in different electrolytes;

FIG. 18D shows the GCD curves of PBA/Zn cycled in NaZn-WiSA as prepared in Example 4 at different current rates;

FIG. 18E shows the cycle performance of PBA/Zn tested in different electrolytes at 1000 milliampere per gram (mA g⁻¹);

FIG. 19A shows a post-mortem characterization of PBA electrodes, in particular a scanning electron microscope (SEM) image of (i) pristine PBA electrode, cycled PBA electrode tested in (ii) NaZn-WiS and (iii) NaZn-WiSA electrolytes as prepared in Example 4;

FIG. 19B shows a post-mortem characterization of PBA electrodes, in particular an energy dispersive X-ray spectroscope (EDX) of cycled PBA electrode tested in NaZn-WiSA electrolyte as prepared in Example 4;

FIG. 19C shows a post-mortem characterization of PBA electrodes, in particular an X-ray diffraction (XRD) of PBA pristine and cycled electrodes after 50 cycles;

FIG. 20A shows post-mortem characterizations of Zn anodes, in particular a SEM of pristine and cycled Zn electrodes;

FIG. 20B shows post-mortem characterizations of Zn anodes, in particular an XRD of pristine and cycled Zn electrodes;

FIG. 21A shows a flammability test, in particular an image of separator after exposure to a naked flame that was pre-soaked in diethyl carbonate solvent as a control;

FIG. 21B shows a flammability test, in particular an image of separator after exposure to a naked flame that was pre-soaked in NaZn-WiSA electrolyte as prepared in Example 4;

FIG. 21C shows a pouch cell with NaZn-WiSA electrolyte as prepared in Example 4 connected to the light-emitting diodes (LEDs), with the LEDs switched off; and

FIG. 21D shows a pouch cell with NaZn-WiSA electrolyte connected to the LEDs, with the LEDs switched on.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

In a first aspect, the present disclosure provides an aqueous electrolyte for a battery, including a water-based solvent having dissolved therein a mixture of a sodium-based salt and a trifluoromethanesulfonate-based salt. Advantageously, the disclosure provides for a low cost, sustainable and safe hybrid ion chemistry for stationary energy storage applications by using an aqueous electrolyte in a battery in order to form, e.g., an aqueous rechargeable hybrid ion battery (ARHB). Advantageously, an affordable and sustainable ARHB may be obtained by employing a combination of salts in the aqueous electrolyte, e.g., a combination of two salts, e.g., sodium and trifluoromethanesulfonate (commonly abbreviated as “triflate”, having the chemical formula “—CF₃SO₃⁻”) salts. Further advantageously, the utilization of an aqueous electrolyte may enable the battery to have enhanced safety compared to the commercial lithium-ion counterpart. Further advantageously, according to some embodiments, a reversible high voltage operation up to 2.2 Volt (V) versus Zn²⁺/Zn and superior cycle stability of PBA/Zn full cell can be obtained by the employment of the aqueous electrolyte as disclosed herein.

The water-based solvent may be the main component of the aqueous electrolyte, meaning that it may have the highest percentage by weight of all components of the aqueous electrolyte. The water-based solvent may be substantially pure water, optionally deionized (Di) water. Alternatively, the water-based solvent may include ion compositions in ppm concentration depending on the source of the water. In some embodiments, the water-based solvent may have a pH that is between 5 and 7.

The aqueous electrolyte may be in the liquid phase, meaning that the combination of salts may be substantially, or completely dissolved in the water-based solvent.

In some embodiments, the water-based solvent may have a pH below 6. More specifically, the pH of the water-based solvent may be between 4 and 6, optionally, at about 5.

In some embodiments, the water-based solvent may include, or may be, rainwater. Advantageously, using rainwater as the water-based solvent may provide for a battery from sustainable and green resources. For example, the tapping on rainwater as an abundant natural resource for energy storage may enable the storage system to be scalable for potential large-scale energy storage applications.

The rainwater, before being used in the aqueous electrolyte, may collect impurities as it falls from the atmosphere. One of these impurities may be atmospheric carbon dioxide, or CO₂, being a weak acid. It is possible for rainwater to combine with other substances in the atmosphere that may increase the alkalinity of its pH, such as suspended soil dust, but most rainwater may ultimately have a pH between 5 and 7, making it slightly acidic. Accordingly, the rainwater may have ion compositions including sulfate in the range of about 0.1 ppm to about 5.0 ppm, or about 1.0 ppm to about 4.0 ppm, or about 1.5 ppm to about 2.0 ppm. In one example, the sulfate may be present at 1.71 ppm. Moreover, the rainwater may have ion compositions including nitrate in the range of about 0.1 ppm to about 5.0 ppm, or about 0.5 ppm to about 3.0 ppm, or about 1.0 ppm to about 2.0 ppm. In one example, the nitrate may be present at 1.1 ppm. Moreover, the rainwater may have ion compositions including chloride in the range of about 0.01 ppm to about 5.0 ppm, or about 0.1 ppm to about 1.0 ppm, or about 0.2 ppm to about 0.5 ppm. In one example, the chloride may be present at 0.38 ppm.

The sodium-based salt may include any salt, wherein at least one ion is sodium. The trifluoromethanesulfonate-based salt may include any salt, wherein the anion is trifluoromethanesulfonate. Hence, it is understood that the aqueous electrolyte includes the presence of at least four ions, including 2 cations and 2 anions, wherein 2 of the 4 ions are sodium and trifluoromethanesulfonate, and the other 2 of the 4 ions are respective counter ions.

In one embodiment, a cation of the sodium-based salt may include sodium. The counter ion of the sodium-based salt may be selected from any anion. In particular, the anion of the sodium-based salt may be an organic anion. The organic anion of the sodium-based salt may be selected from the group consisting of a mesylate, maleate, citrate, tartrate, and a combination thereof. The anion of the sodium-based salt may be an inorganic anion. The inorganic anion may be selected from a halide, e.g., fluoride, chloride, bromide, iodide, and a combination thereof. In other embodiments, the inorganic anion of the sodium-based salt may be selected from the group consisting of a perchlorate, nitrate, chloride, acetate, sulfate, and a combination thereof. In one example, the sodium-based salt includes sodium perchlorate.

In some embodiments, the sodium-based salt may be provided in a concentration (e.g., molality) of about 0.1 moles per kilogram (mol/kg) to about 20 mol/kg, or higher. For instance, in some embodiments, the concentration of the sodium-based salt may be above 10 mol/kg. Advantageously, such a high concentration of the sodium-based salt may be beneficial to reducing the reactivity of the water in the aqueous electrolyte. More specifically, due to the presence of water in the aqueous electrolyte of the ARHB, the untamed (i.e. reactive) water molecules may react with the electrode materials during electrochemical cycling, resulting in undesired side reactions. For instance, the PBA cathode may undergo side reactions with water, such as dissolution and irreversible phase transformation, while dendrite formation and corrosion would occur on the anode (e.g., the zinc metal anode), which may result in inferior cell cycling stability. A high salt concentration, or electrolyte saturation, in the water-based solvent (“water-in-salt; WiS”) of, e.g., above 10 mol/kg may achieve cation coordination of the sodium-based salt with the oxygen of the water. This has the effect that the reactivity of the water molecules of the water-based solvent is reduced, resulting in less side reactions with the electrode materials, and, in turn, having an improved cell cycling stability compared to an aqueous electrolyte with a lower concentration of sodium-based salt. Accordingly, a high salt concentration may advantageously widen the electrochemical stability window of aqueous electrolytes for high voltage electrochemistry.

In some embodiments, the concentration of the sodium-based salt may be in an advantageous range of between about 10 mol/kg to about 20 mol/kg. Below this concentration range, the reactivity of the water-based solvent, as mentioned above, may be too high, and the cell cycling stability may be reduced, while above a concentration of about 20 mol/kg, the solubility of the sodium-based salt may be impaired. Accordingly, the range of between about 10 mol/kg to about 20 mol/kg may ensure a high cell cycling stability, while retaining the aqueous electrolyte in a liquid phase.

In some embodiments, the concentration of the sodium-based salt may be in the range of about 12 mol/kg to about 18 mol/kg, optionally in a concentration of about 14 mol/kg to about 16 mol/kg. In one example wherein the sodium-based salt may be sodium perchlorate, the concentration of the sodium perchlorate may be about 14 mol/kg to about 16 mol/kg, or about 15 mol/kg.

The trifluoromethanesulfonate-based salt may have a cation, being the counter ion to the trifluoromethanesulfonate. The cation of the trifluoromethanesulfonate-based salt may include a metal, optionally an alkali metal, e.g., lithium, sodium, potassium, cesium. Additionally or alternatively, the cation of the trifluoromethanesulfonate-based salt may include an alkaline earth metal, e.g., magnesium, calcium, strontium, barium. Additionally or alternatively, the cation of the trifluoromethanesulfonate-based salt may include an organic cation, e.g., ammonium. Additionally or alternatively, the cation of the trifluoromethanesulfonate-based salt may include a transition metal, e.g., cadmium, mercury, iron, manganese, copper, silver, gold, platinum, cobalt, scandium, vanadium, iridium, rhodium, osmium, ruthenium, titanium, zirconium, and zinc. Additionally or alternatively, the cation of the trifluoromethanesulfonate-based salt may include a post-transition metal, e.g., gallium, indium, thallium, tin, lead, bismuth and aluminum. In one example, the trifluoromethanesulfonate-based salt includes zinc trifluoromethanesulfonate.

The trifluoromethanesulfonate-based salt may be provided in a concentration of about 0.1 mol/kg to about 5 mol/kg, optionally in a concentration of about 0.2 mol/kg to about 2 mol/kg, optionally in a concentration of about 0.3 mol/kg to about 1.5 mol/kg. A high concentration of the trifluoromethanesulfonate-based salt may be beneficial in reducing the reactivity of the water in the aqueous electrolyte, as mentioned above in relation to the sodium-based salt.

Additionally or alternatively to the above, the aqueous electrolyte may further include an organic polar solvent (also termed as “co-solvent” or “additive”). Advantageously, the addition of an organic polar solvent with polar protic/aprotic properties may be beneficial for increasing the pH of the aqueous electrolyte. In particular, the pH of the aqueous electrolyte (without the organic polar solvent) may be from about 2 to about 4, optionally at about 3. The addition of the organic polar solvent may help to increase the pH to be from about 4 to about 6, optionally at about 5. As a result, the aqueous electrolyte, including the organic polar solvent, may help to prevent the corrosion of the cathode and the anode, thereby increasing the life span of the active materials.

In some embodiments, the organic polar solvent may have a dielectric constant of higher than 10, optionally higher than 20, optionally higher than 30, optionally higher than 40. Advantageously, a higher dielectric constant of the organic polar solvent may be beneficial for dissolving the organic polar solvent in the aqueous electrolyte, such that a single-phase electrolyte may be obtained.

In some embodiments, the organic polar solvent may have a dipole moment higher than 1.5 Debye (D), optionally higher than 2 D, optionally higher than 3 D. Advantageously, a higher dipole moment of the organic polar solvent may be beneficial for dissolving the organic polar solvent in the aqueous electrolyte, such that a single-phase electrolyte may be obtained.

As mentioned above, while an aqueous electrolyte may be associated with several advantages compared to conventional electrolytes, it would be beneficial to control (e.g., reduce) the reactivity of the water in the water-based solvent. One of the strategies that is disclosed herein for reducing the strong reactivity of water is to involve a high salt concentration (e.g., “water-in-salt; WiS”). One limitation associated with this strategy is the solubility of the sodium-based salt in the water-based solvent. Accordingly, for complementing said strategy, in some embodiments, the organic polar solvent may be selected from a polar aprotic solvent. Advantageously, when the organic polar solvent is a polar aprotic solvent, hydrogen bonding interaction between the polar aprotic solvent and the water may occur. Such hydrogen bonding interaction may be beneficial for reducing the reactivity of the water, having the advantageous effects as mentioned above.

In some embodiments, the polar aprotic solvent may be selected from the group consisting of acetone, acetonitrile, dimethylformamide, dimethylpropyleneurea, dimethyl sulfoxide, hexamethylphosphoric triamide, and a combination thereof. In one example, the polar aprotic solvent is dimethyl sulfoxide.

In some embodiments, the organic polar solvent may be selected from a polar protic solvent. The polar protic solvent may be selected from the group consisting of formic acid, nitromethane, ethanol, and a combination thereof. In one example, the polar protic solvent is ethanol.

In some embodiments, a volume ratio of the water-based solvent, having dissolved therein the mixture of the sodium-based salt and the trifluoromethanesulfonate-based salt, to the organic polar solvent may be from 5:1 to 1:5. This ratio may depend on the solubility of the mixture of sodium-based salt and trifluoromethanesulfonate-based salt in the water-based solvent, and the organic polar solvent. For example, in some embodiments, the volume ratio of the water-based solvent, having dissolved therein the mixture of the sodium-based salt and the trifluoromethanesulfonate-based salt, to the organic polar solvent may be from 5:1 to 2:1. Additionally, in some cases, a further aliquot of the water-based solvent may be added, e.g., when the organic polar solvent is ethanol.

In another aspect, there is provided a battery including an anode and a cathode, and an aqueous electrolyte ionically coupling the anode and the cathode, wherein the aqueous electrolyte includes a water-based solvent, having dissolved therein a mixture of a sodium-based salt and a trifluoromethanesulfonate-based salt.

In some embodiments, the cathode may be a sodium-based cathode, which, advantageously, is highly abundant. For example, the cathode may include a PBA, such as NaₓFeMn(CN)₆, which advantageously provides a high transition metal redox potential and theoretical capacity (171 milliampere hours per gram (mAh g⁻¹)), which may promise high energy density.

In some embodiments, the anode may be a zinc-based anode, which may have a high theoretical gravimetric capacity (e.g., zinc metal anode has a theoretical capacity of 820 mAh g⁻¹). Further advantageously, its low Zn stripping/plating redox potential (−0.76 V versus standard hydrogen electrode (SHE)) may also enable a high cell voltage with a PBA cathode. Hence, advantageously, the cathode may include PBA and the anode may include zinc, e.g., metal zinc foil.

In some embodiments, the battery may be in a coin cell configuration.

In other embodiments, the battery may be in a pouch cell configuration.

The term “comprising” shall be understood to have a broad meaning similar to the term “including” and will be understood to imply the inclusion of a stated integer or operation or group of integers or operations but not the exclusion of any other integer or operation or group of integers or operations. This definition also applies to variations on the term “comprising” such as “comprise” and “comprises”.

By “about” in relation to a given numerical value, such as for concentration and composition, it is meant to include numerical values within 10% of the specified value.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

### EXAMPLES

Lithium-ion technologies have been dominating the energy market due to their superior energy density. However, its flammable non-aqueous electrolyte content has posed a significant safety concern, limiting its application in large-scale energy storage applications. On the other hand, there are non-flammable alternatives based on water electrolytes, such as alkaline and lead-acid batteries. However, these electrolytes are either corrosive or acidic, and additional safety measures have to be placed in the battery design to prevent the leakage of the electrolytes. Moreover, the toxic lead content would further pose human health and environmental risks. Therefore, it would be ideal to have an energy storage system that can achieve high energy density with safer electrolytes. Herein, the design of a safer, greener, and sustainable rainwater-based rechargeable energy storage system is disclosed, due to the employment of rainwater as the main solvent for the aqueous electrolyte. The rainwater-based electrolyte is formulated by adding a fixed proportion of salts containing the charge carrier ions with a fraction of additive to enhance the overall cycle stability of the electrodes. To test the feasibility of the rainwater-based aqueous stationary rechargeable energy storage system, the prototypes in the form of coin cell (CR2032) and pouch cell are assembled and electrochemically tested.

In one embodiment of this disclosure, a rechargeable energy storage system is based on the utilization and functionalization of safe, green, and sustainable rainwater as electrolyte.

### Advantages and Improvements Over Existing Methods, Devices or Materials

Enhanced fire safety: The utilization of rainwater-based electrolyte enables it to have enhanced safety compared to the commercial lithium-ion counterpart.

Sustainable and green resources: The tapping on the abundant rainwater natural resource for energy storage enables it to be scalable for potential large-scale energy storage applications.

High ionic conductivity of the rainwater-based electrolyte: The prototype can be charged and discharged at a high rate of up to 2 ampere per g (A g⁻¹).

Non-corrosive/acidic nature: The formulated rainwater-based electrolyte is close to neutral pH (pH ˜5), enabling it to be a much safer alternative to alkaline or lead-acid batteries.

### Technical Description of the Disclosure

### Example 1: Rainwater-Based Aqueous Stationary Rechargeable Energy Storage System

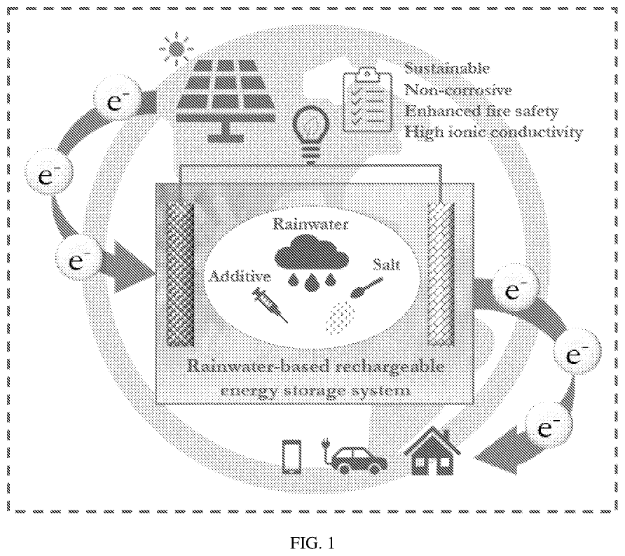

In FIG. 1, there is shown an overview of the promising energy storage applications and unique features of the rainwater-based aqueous stationary energy storage system. The rainwater-based electrolyte is formulated by dissolving a fixed proportion of salts containing the charge carrier ions into the rainwater with a fraction of additive added to enhance the overall cycle stability of the electrodes.

### Example 2: Rainwater-Based Electrolyte Formulation

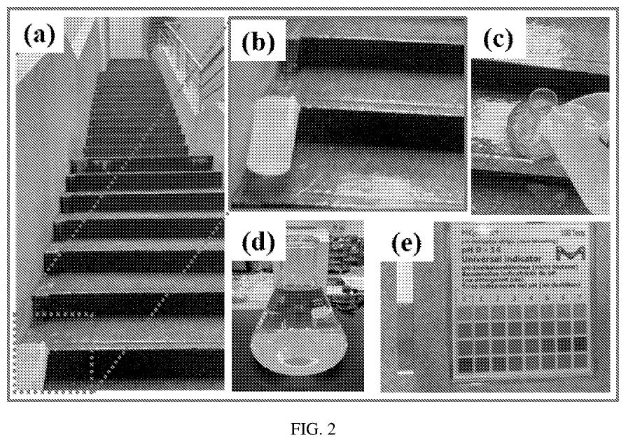

As illustrated in FIG. 2, the collection of rainwater is carried out by placing the plastic beaker at the edge of the unsheltered stairway to collect the flowing rainwater (FIGS. 2(a) and (b)). The rainwater is then transferred to a glass flask for containment and storage (FIGS. 2(c) and (d)). As shown in FIG. 2(e), the pH of the collected rainwater is ˜5.

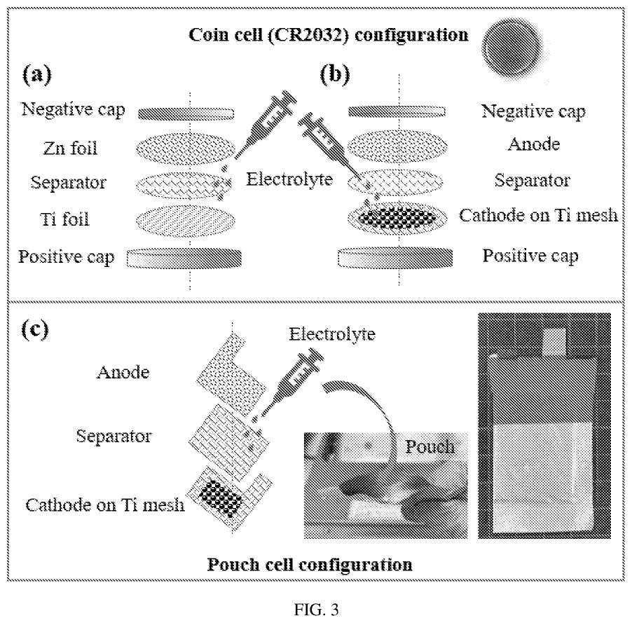

To prove the concept of rainwater-based aqueous stationary rechargeable energy storage system, the high-voltage sodium-based PBA and metallic Zn foil are employed as the model cathode and anode, respectively. To demonstrate the utilization and functionalization of the rainwater as the electrolyte, a mixture of salts consisting of sodium perchlorates (NaClO₄) and zinc trifluoromethanesulfonate (ZnTFS) is dissolved into the rainwater. The rainwater is used as it is without any further treatment before the addition of NaClO₄ and ZnTFS. The cell configurations for the following electrochemical testing are as illustrated in FIG. 3. The electrochemical stability window of the electrolyte is evaluated in a coin cell (CR2032) configuration with titanium (Ti) and Zn foils as working and counter electrodes (FIG. 3a).

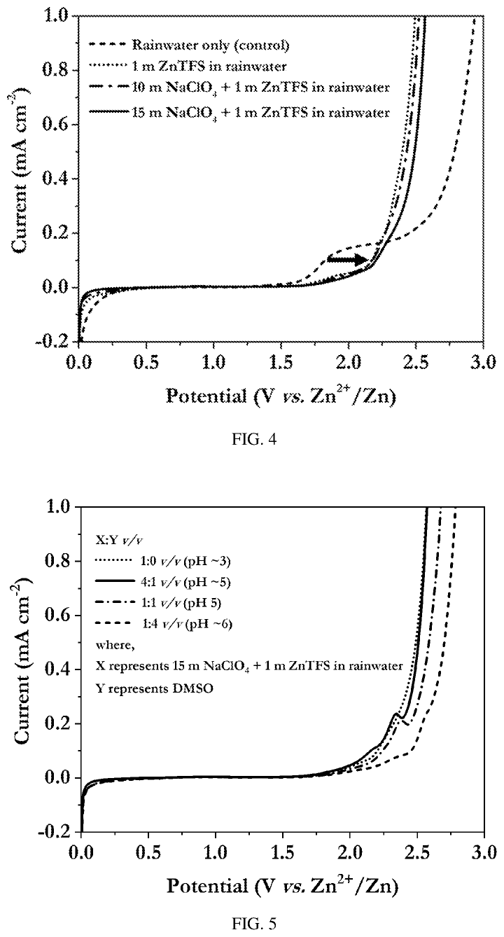

As shown in FIG. 4, as the concentration of the salts increases, the applicable electrochemical potential window of the rainwater (upper limit 1.82 V versus Zn²⁺/Zn) is expanded. It reaches an upper voltage limit of ˜2.2 V versus Zn²⁺/Zn when 15 moles per kilogram (mol/kg) NaClO₄ and 1 mol/kg ZnTFS are added to the rainwater. The voltage limit is determined based on the current cut-off value of 0.1 milliampere per square centimeter (mA cm⁻²). Although it has reached a high voltage limit of 2.2 V versus Zn²⁺/Zn, however, the pH of the electrolyte (15 mol/kg NaClO₄+1 mol/kg ZnTFS in rainwater) is acidic, e.g., about pH ˜3. In this regard, the rainwater-based electrolyte is further modified by adding a small fraction of DMSO as additive in a volume ratio of 1:4 v/v with 15 mol/kg NaClO₄+1 mol/kg ZnTFS in rainwater which increases the pH to ˜5. The adjustment of the pH (closer to neutral pH) could potentially enable the electrode cycle stability. As shown in FIG. 5, the electrochemical stability window of the formulated rainwater-based electrolytes is maintained at ˜2.2 V versus Zn²⁺/Zn (upper cut-off potential). The high voltage cut-off limits of the formulated electrolyte with close to neutral pH ˜5 could enable the reversible operation of the materials with high-voltage redox to achieve higher cell energy density. The selection of salts and additives can be varied depending on the cathode and anode of interest as the prototype here is to demonstrate the utilization and functionalization of the rainwater for the rainwater-based aqueous stationary energy storage system. As illustrated in FIG. 5, the pH of the electrolyte is increased with the increase in the volume ratio of DMSO. Thus, the addition and variation of DMSO amount could be used to adjust the overall pH of the electrolyte (e.g., in the case of acid rain). Here, the DMSO is chosen as a model additive due to its polar and aprotic properties, which enable it to be miscible and have a hydrogen bonding interaction with rainwater. Alternatively, additives with polar and protic properties (e.g., ETH, ethylene glycol, etc.) could also be applied.

### Example 3: Cell Configurations and Electrochemical Testing

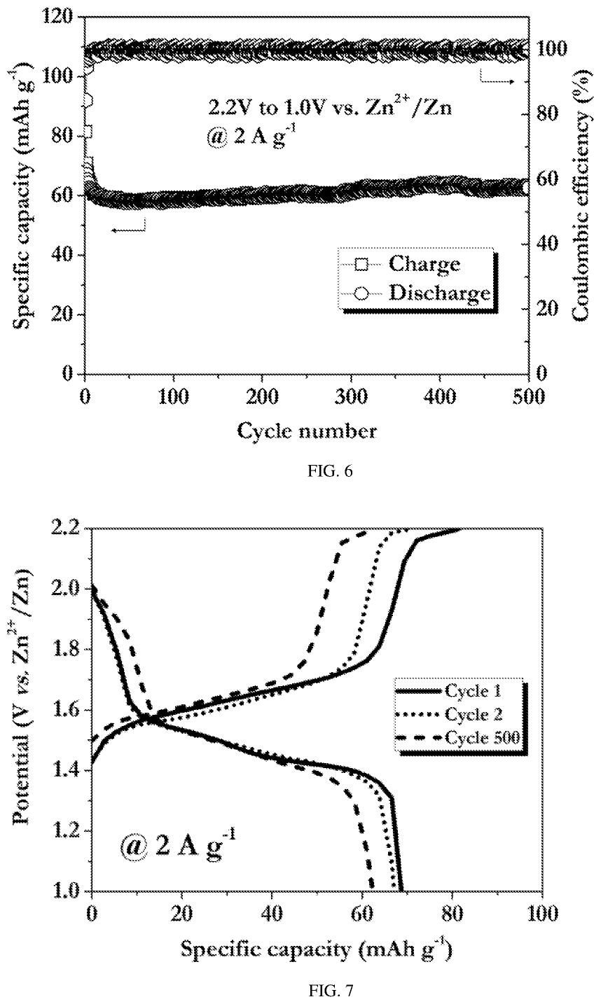

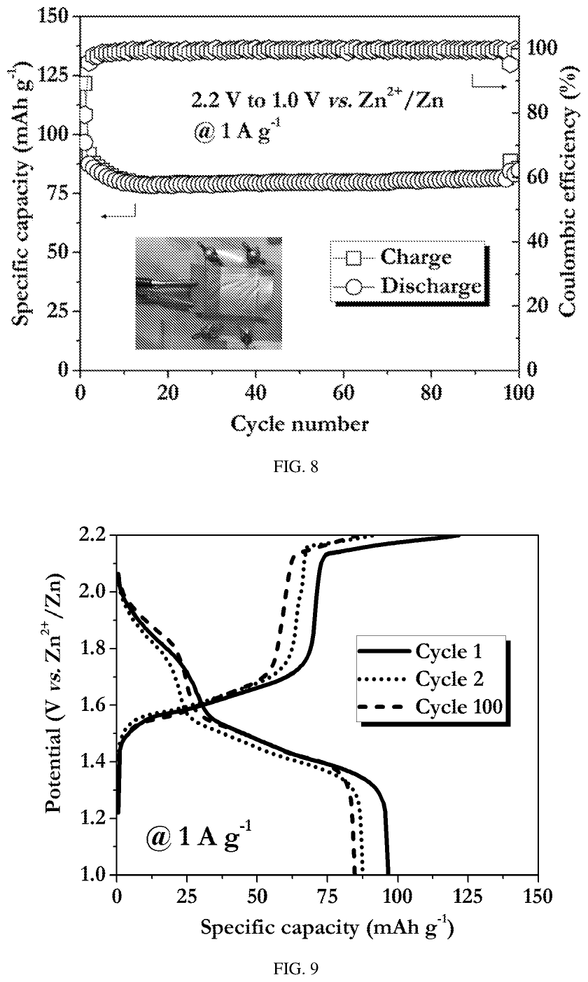

As illustrated in FIG. 3, the prototypes in the form of coin cell (CR2032; FIG. 3b) and pouch cell (FIG. 3c) are assembled and sealed (hydraulic crimping for CR2032 and heat sealing for pouch cell) in the ambient environment. The assembled cells are electrochemically tested between 1.0 to 2.2 V versus Zn²⁺/Zn with the formulated rainwater-based electrolyte to demonstrate the feasibility of the rainwater-based rechargeable energy storage system (FIGS. 6 to 8). In the CR2032 configuration, the PBA/Zn full cell can deliver a high specific discharge capacity of ˜68.8 mAh g⁻¹ at a high current rate of 2 A g⁻¹, with a remarkable capacity retention of ˜91.1% even after 500 cycles (FIG. 6). At a high cell cut-off voltage (2.2 V versus Zn²⁺/Zn), the GCD curves of PBA/Zn full cell are mostly overlapping (FIG. 7). It demonstrates the suitability of the rainwater-based electrolyte that could provide a wide electrochemical stability window for the reversible operation of high-voltage electrodes towards delivering higher cell energy density. In the pouch cell configuration, the PBA/Zn full cell tested in the rainwater-based electrolytes can deliver an initial high specific discharge capacity of ˜96.7 mAh g⁻¹ with an excellent capacity retention of ˜87.6% after 100 cycles (FIG. 8). As shown in FIG. 9, the GCD profiles of PBA/Zn tested in the pouch cell resemble the ones tested in CR2032. The feasibility of the rainwater-based rechargeable energy storage system demonstrated in different cell configurations also means a broader range in adoption and support in various energy storage applications.

In the following, alternative formulations of the aqueous electrolyte are provided with supporting data. The disclosure relates to an electrolyte including:
a) Water;
b) One or more of:
   A perchlorate (ClO₄⁻) salt, ClO₄⁻ (e.g. NaClO₄);
   A nitrate (NO₃⁻) salt, (e.g. NaNO₃);
   A chloride (Cl⁻) salt, (e.g. NaCl);
   An acetate (OAc) salt, (e.g. NaOAc);
   A sulfate (SO₄²⁻) salt, (e.g. Na₂SO₄); and
c) A trifluoromethanesulfonate (triflate, CF₃SO₃⁻) salt, (e.g. Zn(CF₃SO₃)₂); and optionally
d) An organic co-solvent (e.g. DMSO, DMF, ACN, ETH).
   The water may preferably be rainwater.

Prototypes in the form of coin cell (CR2032) and pouch cell were assembled and electrochemically tested. As the cathode, a sodium-based PBA cathode, and as the anode, a metallic Zn foil may be employed. The prototypes demonstrated a high specific discharge capacity and capacity retention.

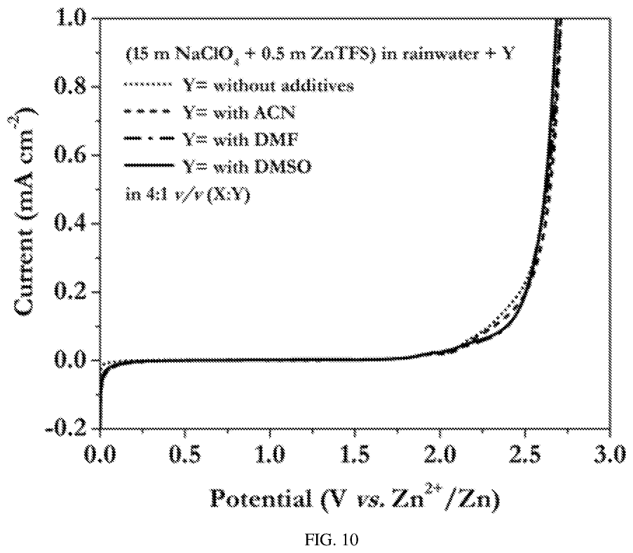

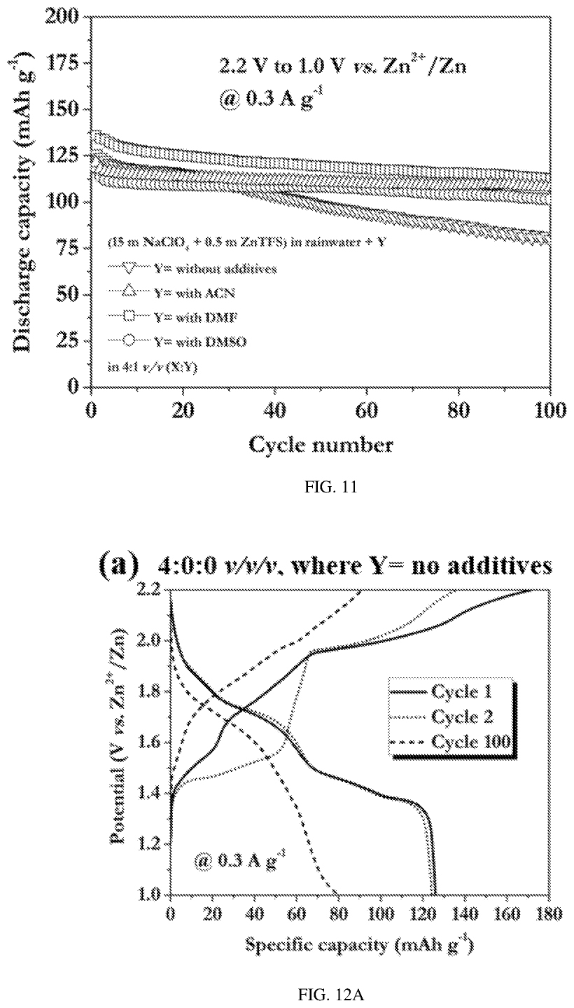

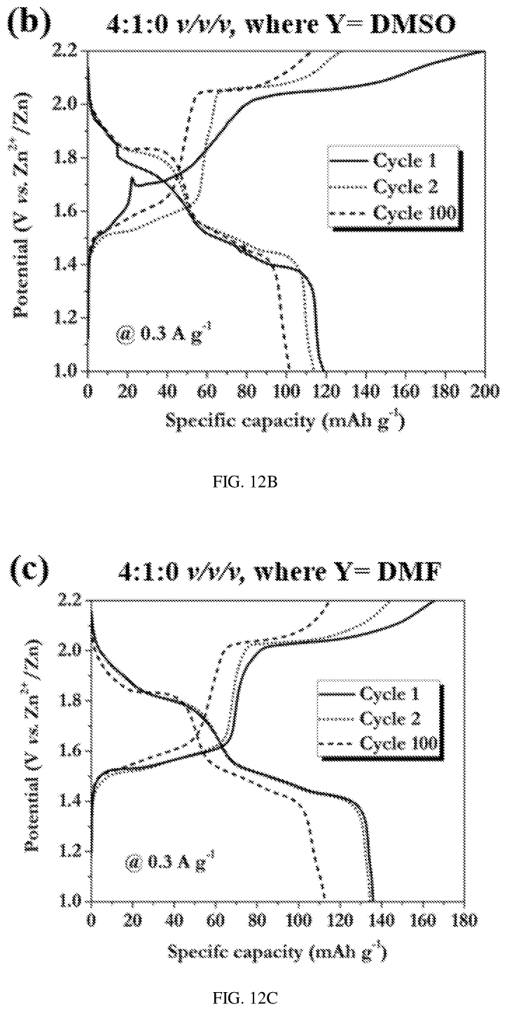

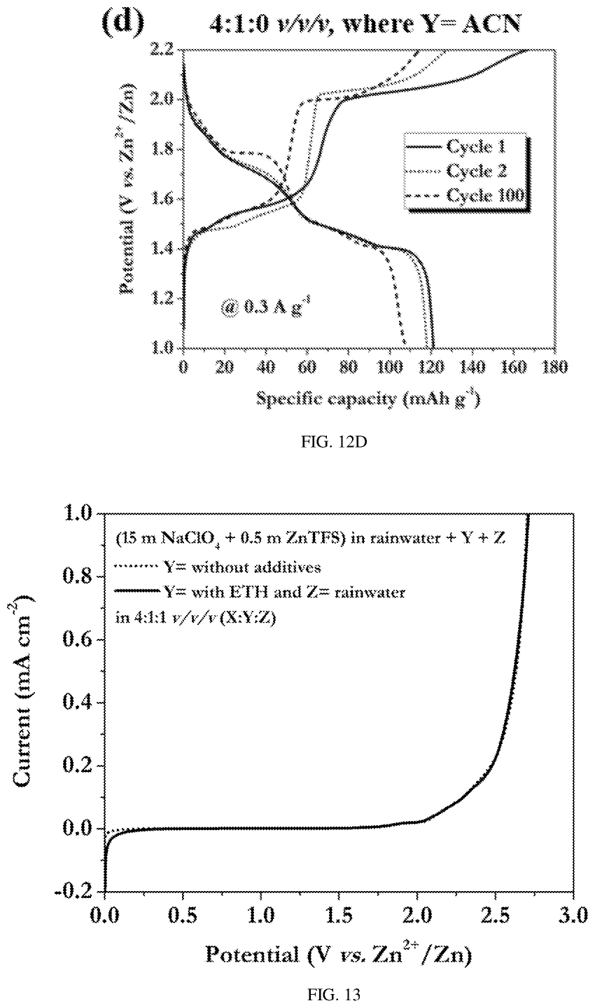

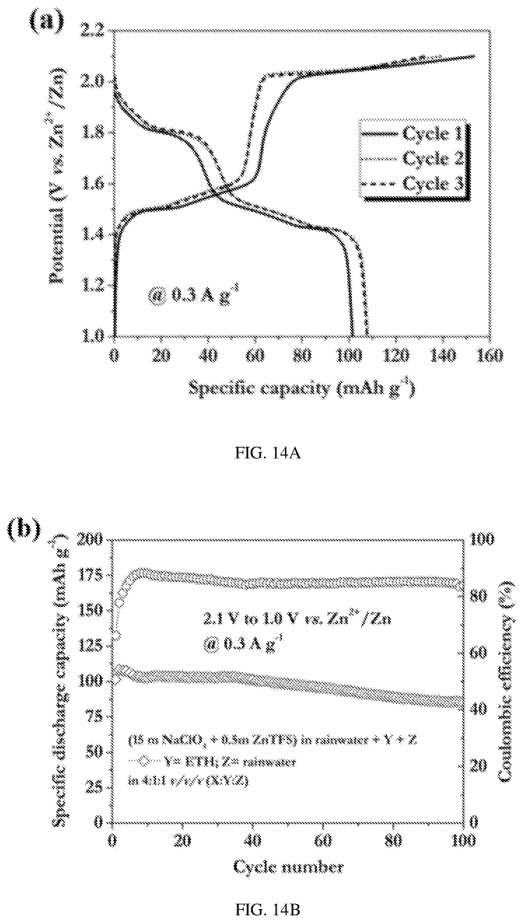

Besides DMSO, the alternative organic co-solvents that may be employed include ACN, DMF and ETH. Formulated electrolytes with different organic co-solvents and their respective results:
(i) Polar aprotic-based (DMSO, ACN, DMF); (FIGS. 10 to 12, Table 1)
(ii) Polar protic-based (ETH); (FIGS. 13 and 14, Table 2)

For ETH to be employed, an electrolyte formulation of (X:Y:Z v/v/v) is applied, where (Z) is a diluent component comprising of excess rainwater in fixed volume ratio added to prevent salt crystallization.

TABLE 1
Electrochemical performance of PBA/Zn cycled in rainwater-
based electrolyte formulations, without and with different
polar aprotic-based additives (DMSO, DMF, and ACN), at a
current density of 0.3 A g⁻¹.

| | Energy | | |
|---|---|---|---|
| | Density | | |
| | (Wh kg⁻¹) | Specific | |
| Rainwater- | Based on | discharge | Capacity |
| based | active | capacity | retention |
| electrolyte | cathode | (1^{st} cycle; | after |
| formulations | mass | mAh g⁻¹) | 100 cycles |
| 4:0:0 v/v/v | ~200.3 | ~126.0 | ~52.8% |
| Y = no additives | | | |
| 4:1:0 v/v/v | ~188.0 | ~118.6 | ~85.6% |
| Y = DMSO | | | |
| 4:1:0 v/v/v | ~192.1 | ~121.2 | ~89.2% |
| Y = ACN | | | |
| 4:1:0 v/v/v | ~222.2 | ~136.0 | ~82.9% |
| Y = DMF | | | |

TABLE 2
Electrochemical performance of PBA/Zn cycled in rainwater-based
electrolyte formulations, without and with a polar protic-based
additives (e.g., ETH), at a current density of 0.3 A g⁻¹.

| | Energy Density | | |
|---|---|---|---|
| | (Wh kg⁻¹) | Specific | |
| Rainwater- | Based on | discharge | Capacity |
| based | active | capacity | retention |
| electrolyte | cathode | (1^{st} cycle; | after 100 |
| formulations | mass | mAh g⁻¹) | cycles |
| 4:1:1 v/v/v | ~161.7 | ~101.5 | ~84.4% |
| Y = ETH | | | |
| Z = Diluent (excess | | | |
| rainwater added to | | | |
| prevent crystallization) | | | |

Besides sodium perchlorate (NaClO₄), the electrolyte formulations with alternative sodium-based salts with different anions include:
(i) nitrate (NO₃⁻) salt (e.g., NaNO₃),
(ii) chloride (Cl⁻) salt, (e.g., NaCl),
(iii) acetate (OAc) salt, (e.g., NaOAc), and
(iv) sulfate (SO₄²⁻) salt, (e.g., Na₂SO₄)

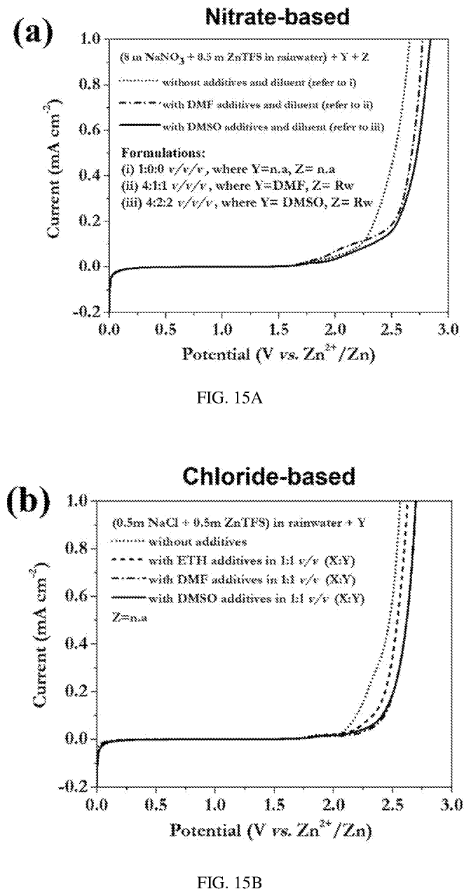

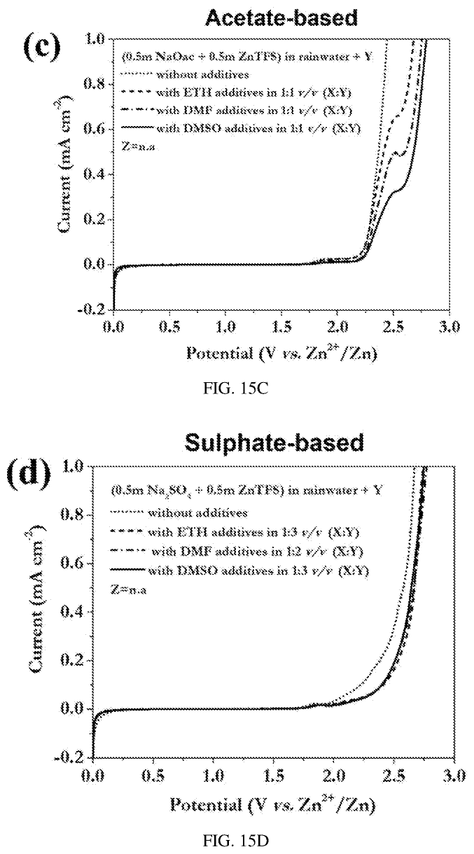

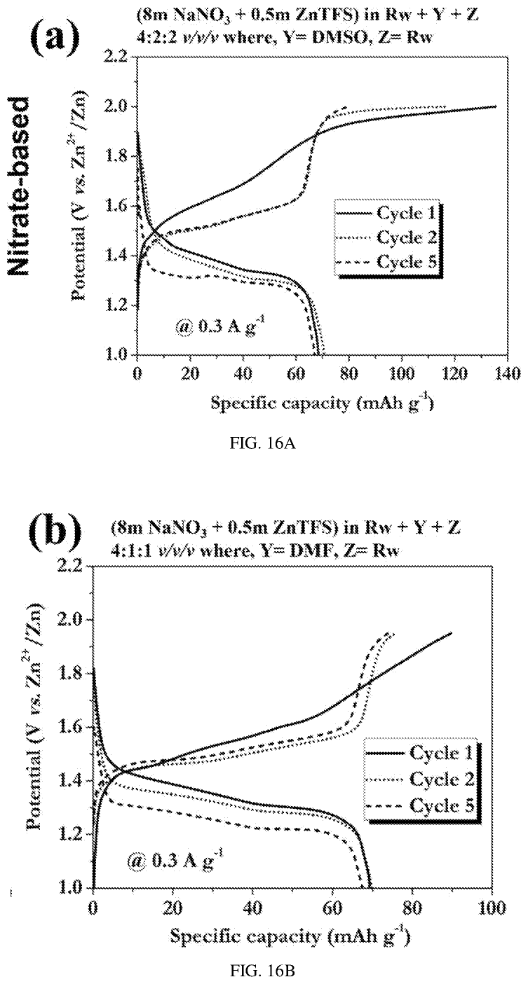

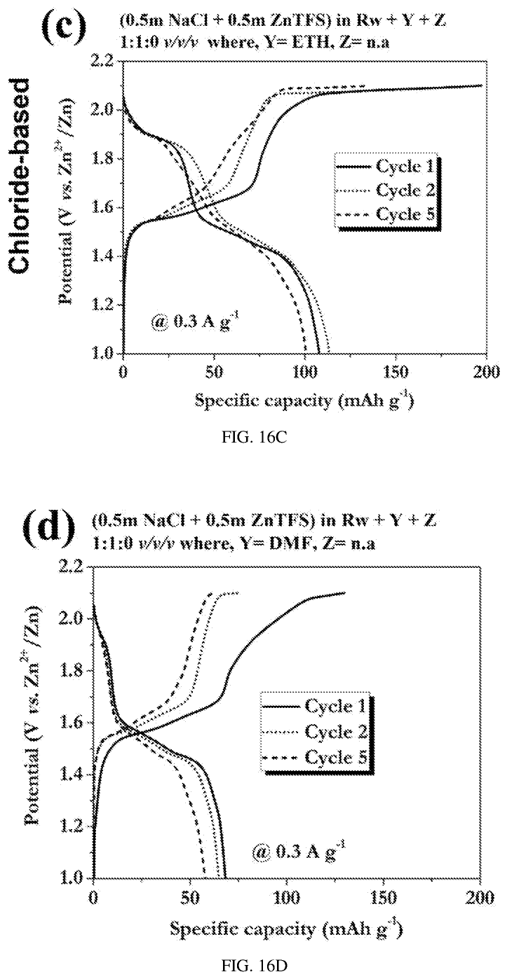

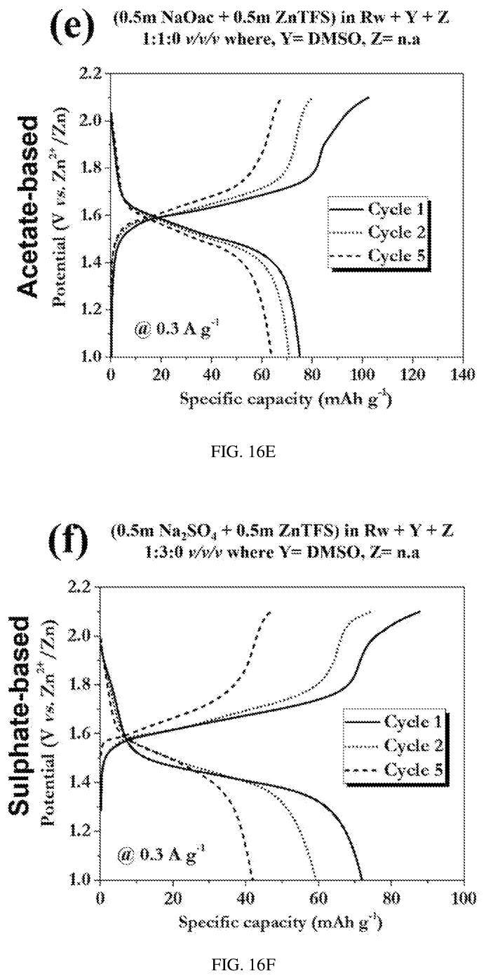

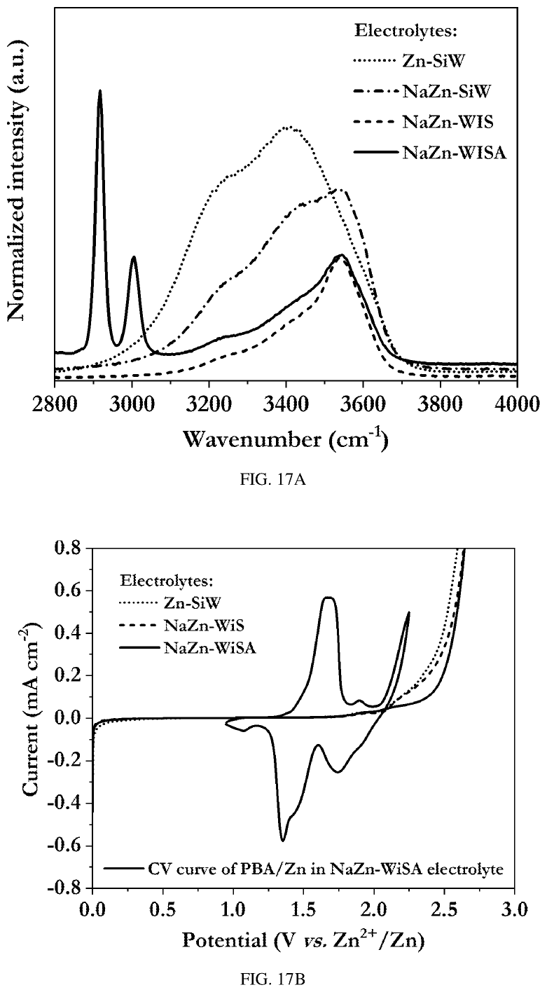

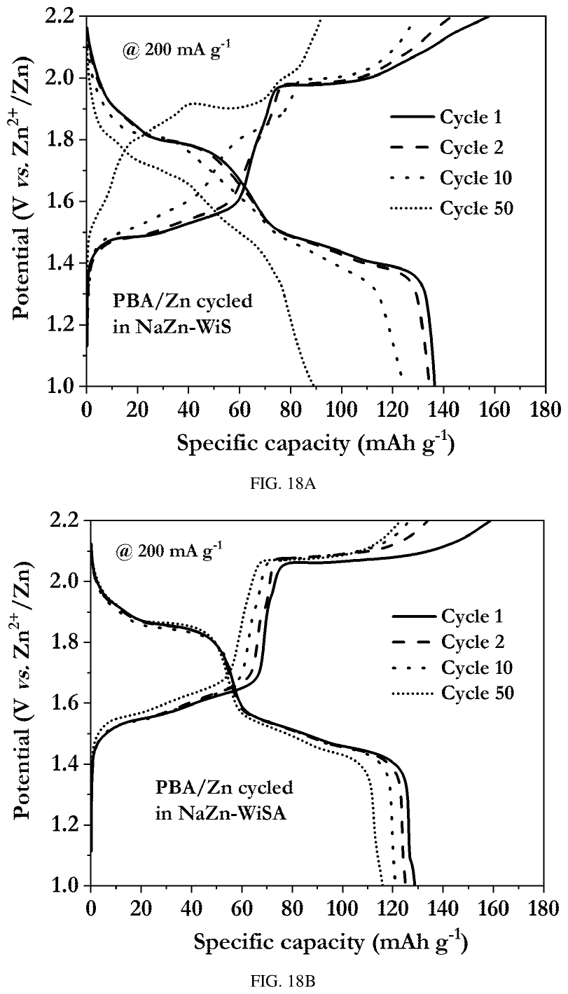

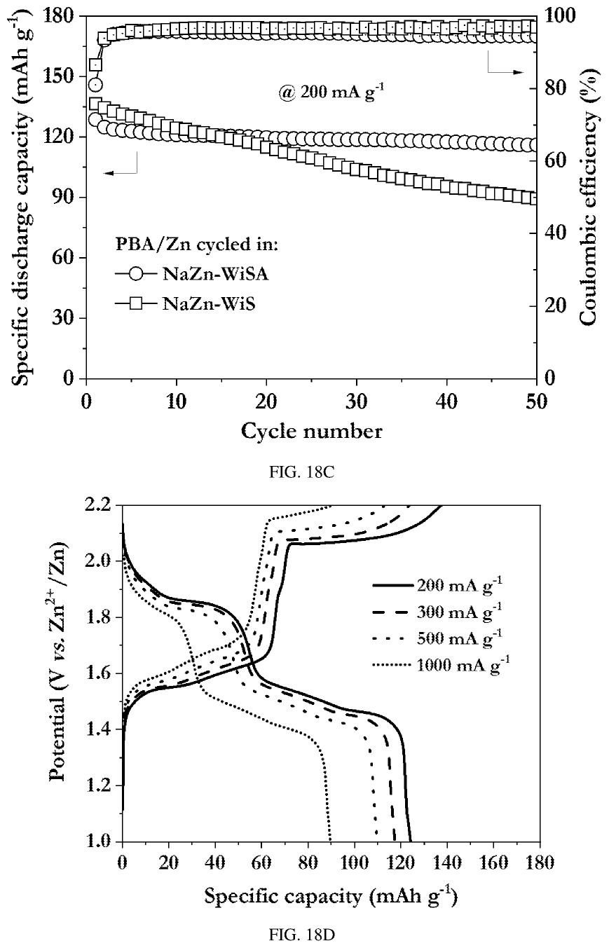

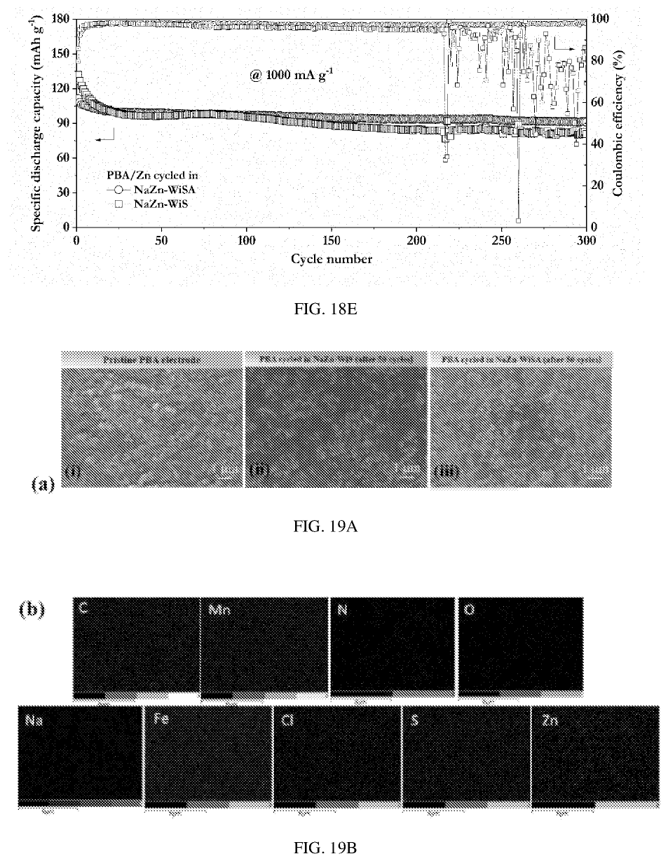

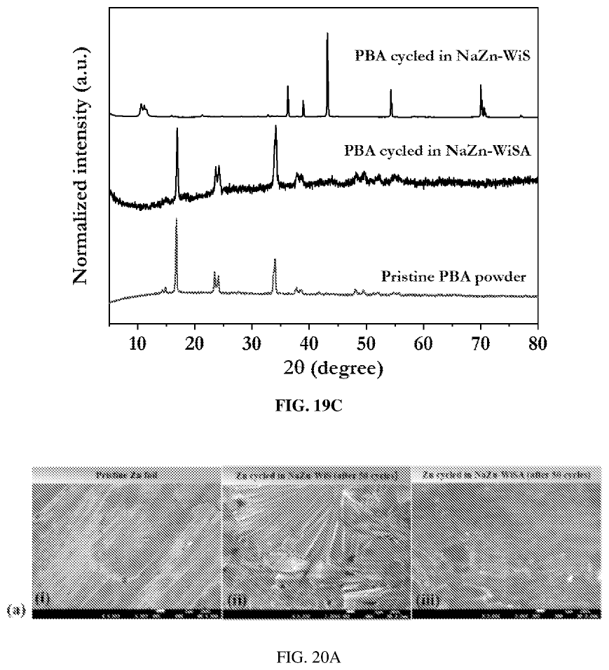

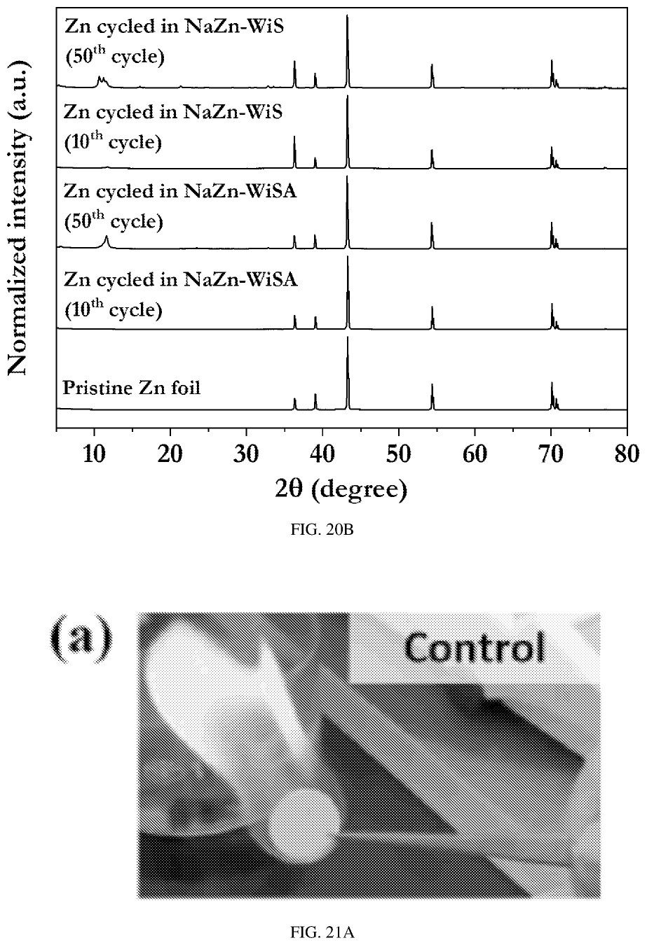

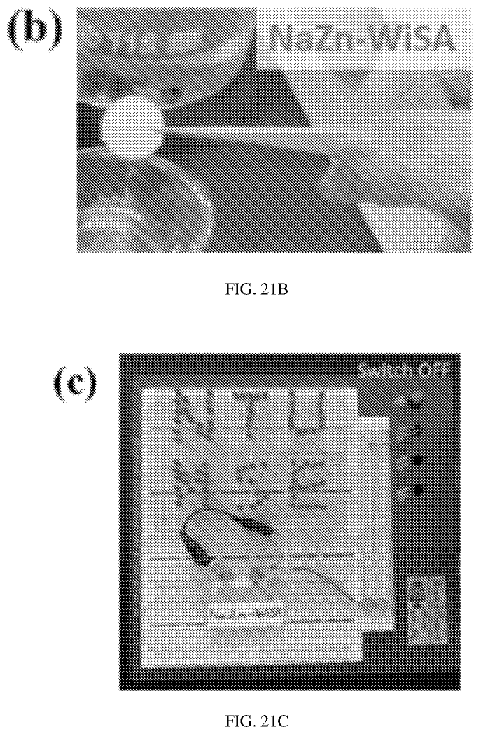

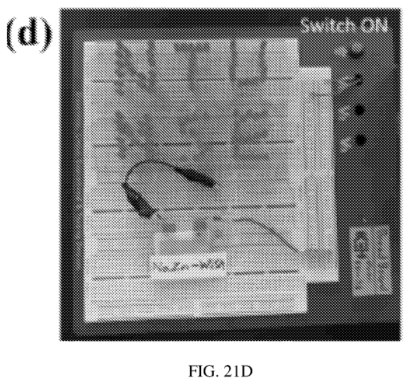

The electrochemical stability window of the optimized electrolytes and the electrochemical performances of the full cell (PBA/Zn) cycled in the electrolytes with different sodium-based salts are as shown in FIGS. 15 and 16, respectively. Note: The concentration of the sodium-based salts and fractions of organic solvent/diluent are optimized to ensure the solubility of salts in the formulated electrolytes.

TABLE 3
Summary list of some rainwater-based electrolyte formulations

| | | | | Formulation | |
|---|---|---|---|---|---|
| | | | | [X:Y:Z] (v/v/v) | |
| | | | | where, | |
| | | | | X is salt (A + B) dissolved in rainwater, | |
| | | | | Y is additive (organic co-solvent), | |
| Salt A | | Salt B | | Z is diluent\hat{ } | pH |
| A = NaClO₄ | | B = ZnTFS | | X = A + B in rainwater | |
| | | | | Y = Polar aprotic-based additive (DMSO); | |
| | | | | Z = N.A | |
| 15 | mol/kg | 1 | mol/kg | 1:0:0 | ~3 |
| 15 | mol/kg | 1 | mol/kg | 4:1:0 | ~5 |
| 15 | mol/kg | 1 | mol/kg | 1:1:0 | ~5 |
| 15 | mol/kg | 1 | mol/kg | 1:4:0 | ~6 |
| 15 | mol/kg | 0.5 | mol/kg | 1:0:0 | ~3 |
| 15 | mol/kg | 0.5 | mol/kg | 4:1:0 | ~4 |
| A = NaClO₄ | | B = ZnTFS | | X = A + B in rainwater | |
| | | | | Y = Alternative polar aprotic-based additives | |
| | | | | (ACN/DMF) | |
| | | | | Z = N.A | |
| 15 | mol/kg | 0.5 | mol/kg | 4:1:0 (Y = DMF; Z = N.A) | ~4 |
| 15 | mol/kg | 0.5 | mol/kg | 4:1:0 (Y = ACN; Z = N.A) | ~4 |
| A = NaClO₄ | | B = ZnTFS | | X = A + B in rainwater | |
| | | | | Y = Alternative polar protic-based additives (ETH) | |
| | | | | Z = with diluent | |
| 15 | mol/kg | 0.5 | mol/kg | 4:1:1 (Y = ETH; Z = rainwater) | ~4 |
| A = NaNO₃ | | B = ZnTFS | | X = A + B in rainwater | |
| | | | | Y = Polar aprotic-based additives | |
| | | | | Z = without/with diluent | |
| 8 | mol/kg | 0.5 | mol/kg | 1:0:0 | ~4 |
| 8 | mol/kg | 0.5 | mol/kg | 4:1:1 (Y = DMF; Z = rainwater) | ~5 |
| 8 | mol/kg | 0.5 | mol/kg | 4:2:2 (Y = DMSO; Z = rainwater) | ~5 |
| A = NaCl | | B = ZnTFS | | X = A + B in rainwater | |
| | | | | Y = Polar aprotic/protic-based additives | |
| | | | | (DMF/DMSO/ETH) | |
| | | | | Z = N.A | |
| 0.5 | mol/kg | 0.5 | mol/kg | 1:0:0 | ~5 |
| 0.5 | mol/kg | 0.5 | mol/kg | 1:1:0 (Y = DMF) | ~5 |
| 0.5 | mol/kg | 0.5 | mol/kg | 1:1:0 (Y = DMSO) | ~5 |
| 0.5 | mol/kg | 0.5 | mol/kg | 1:1:0 (Y = ETH) | ~5 |
| A = NaOAc | | B = ZnTFS | | X = A + B in rainwater | |
| | | | | Y = Polar aprotic/protic-based additives | |
| | | | | (DMF/DMSO/ETH) | |
| | | | | Z = N.A | |
| 0.5 | mol/kg | 0.5 | mol/kg | 1:0:0 | ~5 |
| 0.5 | mol/kg | 0.5 | mol/kg | 1:1:0 (Y = DMF) | ~6 |
| 0.5 | mol/kg | 0.5 | mol/kg | 1:1:0 (Y = DMSO) | ~6 |
| 0.5 | mol/kg | 0.5 | mol/kg | 1:1:0 (Y = ETH) | ~5 |
| A = Na₂SO₄ | | B = ZnTFS | | X = A + B in rainwater | |
| | | | | Y = Polar aprotic/protic-based additives | |
| | | | | (DMF/DMSO/ETH) | |
| | | | | Z = N.A | |
| 0.5 | mol/kg | 0.5 | mol/kg | 1:0:0 | ~5 |
| 0.5 | mol/kg | 0.5 | mol/kg | 1:2:0 (Y = DMF) | ~5 |
| 0.5 | mol/kg | 0.5 | mol/kg | 1:3:0 (Y = DMSO) | ~5 |
| 0.5 | mol/kg | 0.5 | mol/kg | 1:3:0 (Y = ETH) | ~5 |

Note:
ZnTFS—zinc trifluoromethanesulfonate,
OAc—acetate,
DMSO—dimethyl sulfoxide,
DMF—dimethylformamide,
ACN—acetonitrile,
ETH—ethanol
Diluent (using additional rainwater; Z) is only applied in cases where salt crystallization occurs

ARHB has garnered significant attention for grid-scale energy storage applications due to its intrinsic high safety and low cost. However, due to the intrinsic narrow electrochemical stability window of water (˜1.23 V) and parasitic side reactions occurring between water and electrodes during electrochemical cycling, the cell energy output is limited with inferior cycle life. Herein, a green electrolyte formulation is proposed based on an aqueous electrolyte with DMSO as an additive (NaZn-WiSA). With the effective taming of water activities and a regulated pH, the proposed NaZn-WiSA electrolyte enables high voltage operation (up to 2.2 V versus Zn²⁺/Zn), and superior electrochemical performances of a PBA/Zn battery with a high energy density of ˜211.4 watt-hours per kilogram (Wh kg⁻¹) at 0.2 A g⁻¹ (based on active cathode mass). Moreover, the full cell also exhibits excellent high-rate capability and cycle stability with a capacity retention of ˜82% after 300 cycles at 1 A g⁻¹. This disclosure can pave the way toward the future design of ARHB electrolytes based on alternative ions and bring ARHB a step closer to practical applications for stationary energy storage and beyond.

### Example 4: Electrolyte Preparation

Single and hybrid-ions electrolytes are prepared as follows: (i) Zn “salt-in-water” (SiW) electrolyte [0.5 mol/kg Zn(CF₃SO₃)₂; ZnTFS dissolved in Di water], (ii) hybrid sodium-zinc ions (NaZn)-SiW electrolyte [5 mol/kg NaClO₄+0.5 mol/kg ZnTFS dissolved in Di water], (iii) NaZn-“Water-in-salt” electrolyte [15 mol/kg NaClO₄+0.5 mol/kg ZnTFS dissolved in Di water] and (iv) NaZn-“Water-in-salt” with additive (WiSA) electrolyte [15 mol/kg NaClO₄+0.5 mol/kg ZnTFS dissolved in Di water added with 2.1 mol/kg of DMSO].

### Example 5: Electrolyte Characterization

Raman spectroscopy measurement is conducted on the electrolyte using Confocal Raman (488 nm). The pH of the electrolyte is determined using pH paper. A conductivity meter is used to measure the conductivity of the electrolyte.

### Example 6: Synthesis of PBA

First, 0.97 g of Na₄FeCN·10H₂O powder and 15 g of NaCl is dissolved into 100 ml of Di water to get solution A. Separately, 0.68 g of MnSO₄·H₂O is dissolved into 50 ml of Di water under continuous stirring and added with 10 g of NaCl to get solution B. At a constant heating temperature of 50° C., solution B is added dropwise into solution A with continuous stirring for 12 hours. The precipitated powder is centrifuged, washed with Di water and dried in a vacuum oven for 48 hours at 80° C.

### Example 7: Cell Assembly and Electrochemical Testing

The cell is assembled into a coin cell configuration using CR2032 cell parts. The positive electrode is prepared by mixing the active material (PBA) with super P conductive carbon and teflonized acetylene black (CTAB-2) binder in the 7:2:1 weight ratio. The positive electrode mixture is pelletized and pressed onto a Titanium mesh (Good fellow) using a hydraulic press with a pressure of 5 tons. Zn foil (Good fellow) with a diameter of 15 millimeters is used as the anode, and glass fibre Whatman filter paper is used as the separator. The NaZn-WiS and NaZn-WiSA are used as the electrolytes. Cyclic voltammetry and linear sweep voltammetry measurements are conducted on the assembled cell using Biologic battery testers (SP200). GCD measurements are conducted using Neware battery tester.

### Example 8: Post-Mortem Characterizations

The morphological structure and elemental composition of the electrodes are characterized using both field emission scanning electron microscope (FESEM 7600F) and transmission electron microscope (TEM 2100F) coupled with an EDX. The phase characterization of the electrodes is determined using a Bruker X-ray diffractometer. The oxidation states of the transition metals in the electrodes at different charge states are determined via synchrotron-based X-ray absorption near-edge structure spectroscopy, conducted in Beamline 5.2 located at Synchrotron Light Research Institute (Public Organization), Muang, Nakhon Ratchasima, 30000, Thailand.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. An aqueous electrolyte for a battery, comprising a water-based solvent having dissolved therein a mixture of a sodium-based salt and a trifluoromethanesulfonate-based salt.

2. The aqueous electrolyte of claim 1, wherein the water-based solvent has a pH below 6.

3. The aqueous electrolyte of claim 1, wherein the water-based solvent comprises rainwater.

4. The aqueous electrolyte of claim 1, wherein a cation of the sodium-based salt comprises sodium and an anion of the sodium-based salt is selected from the group consisting of perchlorate, nitrate, chloride, acetate, sulfate, and a combination thereof.

5. The aqueous electrolyte of claim 1, wherein the sodium-based salt is provided in a concentration of about 0.1 mol/kg to about 20 mol/kg.

6. The aqueous electrolyte of claim 1, wherein the sodium-based salt comprises sodium perchlorate.

7. The aqueous electrolyte of claim 6, wherein the sodium perchlorate is provided in a concentration of 10 mol/kg to 20 mol/kg.

8. (canceled)

9. The aqueous electrolyte of claim 1, wherein the trifluoromethanesulfonate-based salt is provided in a concentration of 0.1 mol/kg to 5 mol/kg.

10. The aqueous electrolyte of claim 1, further comprising an organic polar solvent.

11. The aqueous electrolyte of claim 10, wherein the organic polar solvent has a dielectric constant of higher than 10.

12. The aqueous electrolyte of claim 10, wherein the organic polar solvent has a dipole moment higher than 1.5 D.

13. The aqueous electrolyte of claim 10, wherein the organic polar solvent is selected from a polar aprotic solvent.

14. The aqueous electrolyte of claim 13, wherein the polar aprotic solvent is dimethyl sulfoxide.

15. The aqueous electrolyte of claim 10, wherein the organic polar solvent is selected from a polar protic solvent.

16. The aqueous electrolyte of claim 15, wherein the polar protic solvent is ethanol.

17. The aqueous electrolyte of claim 10, wherein a volume ratio of the water-based solvent, having dissolved therein the mixture of the sodium-based salt and the trifluoromethanesulfonate-based salt, to the organic polar solvent is from 5:1 to 1:5.

18. (canceled)

19. The aqueous electrolyte of claim 10, wherein a pH of the aqueous electrolyte is from 4 to 6.

20. A battery comprising an anode and a cathode, and an aqueous electrolyte ionically coupling the anode and the cathode, wherein the aqueous electrolyte comprises a water-based solvent, having dissolved therein a mixture of a sodium-based salt and a trifluoromethanesulfonate-based salt.

21. The battery of claim 20, wherein the battery is in a coin cell configuration.

22. The battery of claim 20, wherein the battery is in a pouch cell configuration.
